(19) United States
(12) Patent Application Publication
(10) Pub. No.: US 2008/0157917 A1
(43) Pub. Date: Jul. 3, 2008

(54) Method to increase capacity of a passive element to inrush current

(75) Inventor: Kejian Tu, Changzhou City (CN)

Correspondence Address: Joe McKinney Muncy, PO Box 1364, Fairfax, VA, 22038-1364, US

(73) Assignee: THINKING ELECTRONIC INDUSTRIAL CO., LTD.

(21) Appl. No.: 11/647,292

(22) Filed: Dec. 29, 2006

(51) Int. Cl. H01C 7/108

(52) U.S. Cl. 338/22 R; 338/20

(57) ABSTRACT

A method to increase capacity of a passive element to accommodate inrush current is mounting a metal pad in a circuit to evenly distribute the current over a greater area so heating caused by the current to be distributed over a greater area. The passive element has two electrodes attached on a ceramic disc and connecting respectively to two terminals. The metal pad is mounted between one of the electrodes and the corresponding terminal to increase the contact surface between the electrode and the terminal. Then the current passing from the metal pad to the electrode is distributed evenly. Therefore, when the inrush current passes through the circuit, the electrode will not be melted easily to ensure the passive element working normally most of the time.

### BACKGROUND OF THE INVENTION

1. Field of the Invention

The present invention relates to a method to increase a passive element's capacity to accommodate inrush current. The present invention also relates to a passive element such as a metal oxide varistor (MOV) and thermal metal oxide varistor (T-MOV), especially to a passive element that has an ability to withstand inrush current.

2. Description of the Prior Arts

Conventional passive elements such as varistors can be divided into two types that either contain or do not contain over-current protection.

With reference to FIGS. 5 to 8, a conventional varistor with over-current protection comprises a ceramic disk (70), two silver electrodes (71), a first terminal (72), a second terminal (73), an insulation substrate (74) and a fuse (75). The ceramic disc (70) has two sides. The silver electrodes (71) are attached respectively to the two sides of the ceramic disc (70). The first and second terminals (72, 73) connect respectively to the silver electrodes (71). The insulation substrate (74) is mounted between one of the silver electrodes (71) and the first terminal (72). The fuse (75) connects to one of the silver electrode (71) and the first terminal (72) and has a small contact surface on the silver electrode (71). When inrush current passes through the conventional varistor with over-current protection, the current generates heat. The heat burns the contact surface between the electrode (71) and the first terminal (72). Therefore the conventional varistor is easily damaged.

With reference to FIGS. 9 and 10, a conventional varistor without over-current protection comprises a ceramic disc (70), two silver electrodes (71), a first terminal (72) and a second terminal (73). The ceramic disc (70) has two sides. The silver electrodes (71) are attached respectively to the two sides of the ceramic disc (70). The first and second terminals (72, 73) connect respectively to the silver electrodes (71). The first terminal (72) contacts the silver electrode (71) along a linear surface. The linear contacting surface on the silver electrode (71) increases the contacting area that allows the conventional varistor to accommodate a larger current. However, direct contact between the silver electrode (71) and the first terminal (72) also causes the contacting surface to be burned when the inrush current passes through the conventional varistor.

To overcome the shortcomings, the present invention provides a method to increase capacity of a passive element to accommodate inrush current to mitigate or obviate the aforementioned problems.

### SUMMARY OF THE INVENTION

The main objective of the present invention is to provide a method to increase capacity of a passive element to accommodate inrush current. The method to increase capacity of a passive element to accommodate inrush current is mounting a metal pad in a circuit to evenly distribute the current over a greater area so heating caused by the current to be distributed over a greater area. The passive element has two electrodes attached on a ceramic disc and connecting respectively to two terminals. The metal pad is mounted between one of the electrodes and the corresponding terminal to increase the contact surface between the electrode and the terminal. Then the current passing from the metal pad to the electrode is distributed evenly. Therefore, when the inrush current passes through the circuit, the electrode will not be melted easily to ensure the passive element working normally most of the time.

Other objectives, advantages and novel features of the invention will become more apparent from the following detailed description when taken in conjunction with the accompanying drawings.

### BRIEF DESCRIPTION OF THE DRAWINGS

FIG. 1 is a front view of a first embodiment of a passive element in accordance with the present invention;

FIG. 2 is a side view of the passive element in FIG. 1;

FIG. 3 is a front view of a second embodiment of a passive element in accordance with the present invention;

FIG. 4 is a side view of the passive element in FIG. 3;

FIG. 5 is a front view of a first embodiment of a conventional varistor in accordance with the prior art;

FIG. 6 is a side view of the conventional varistor in FIG. 5;

FIG. 7 is a front view of a second embodiment of a conventional varistor in accordance with the prior art;

FIG. 8 is a side view of the conventional varistor in FIG. 7;

FIG. 9 is a front view of a third embodiment of a conventional varistor in accordance with the prior art; and

FIG. 10 is a side view of the conventional varistor in FIG. 9.

### DETAILED DESCRIPTION OF THE PREFERRED EMBODIMENTS

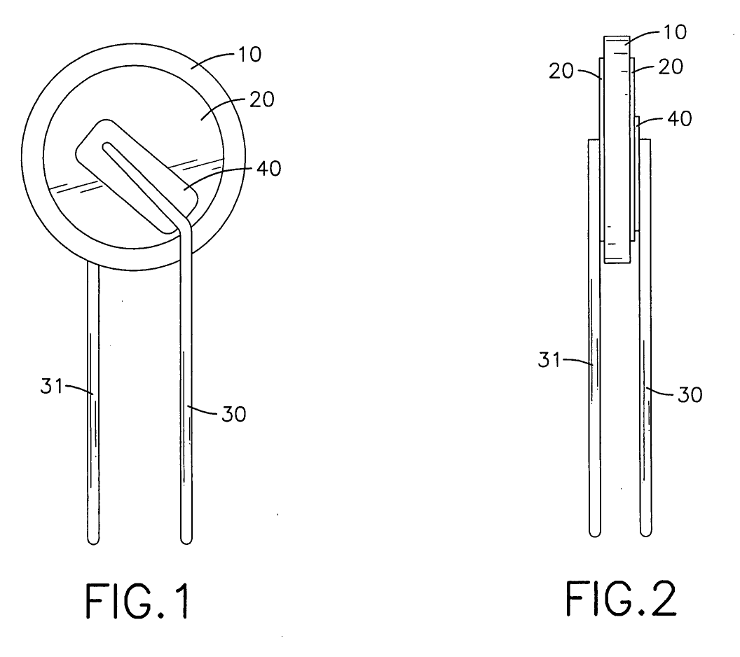

With reference to FIGS. 1 and 2, a passive element in accordance with the present invention comprises a ceramic disc (10), two silver electrodes (20), a first terminal (30), a second terminal (31) and a metal pad (40).

The silver electrodes (20) are attached respectively to two sides of the ceramic disc (10). The first and second terminals (30, 31) connect respectively to the silver electrodes (20) across the ceramic disc (10). The metal pad (40) is mounted between one of the silver electrode (20) and the first terminal (30). The metal pad (40) is made of metal that has a high electric conductivity and may be a copper sheet, a silver-plated copper sheet or a tin-plated copper sheet.

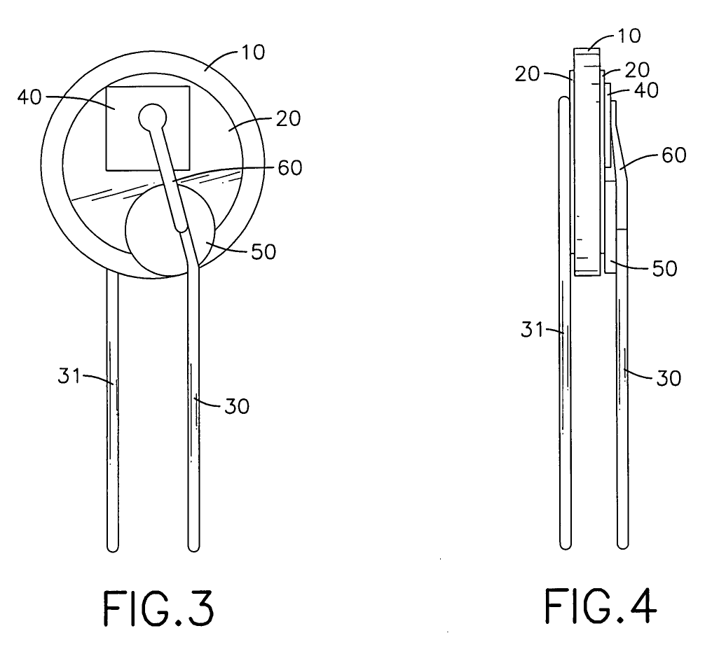

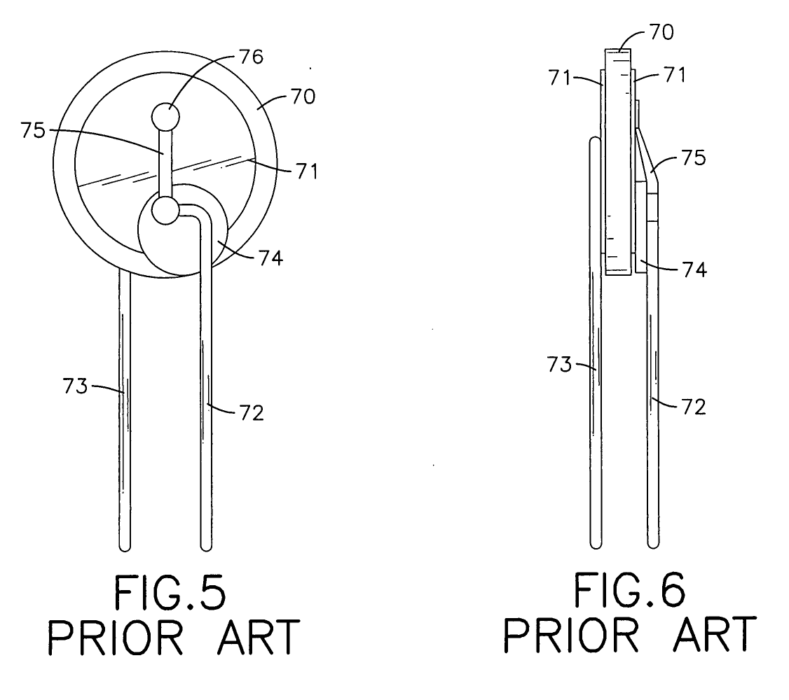

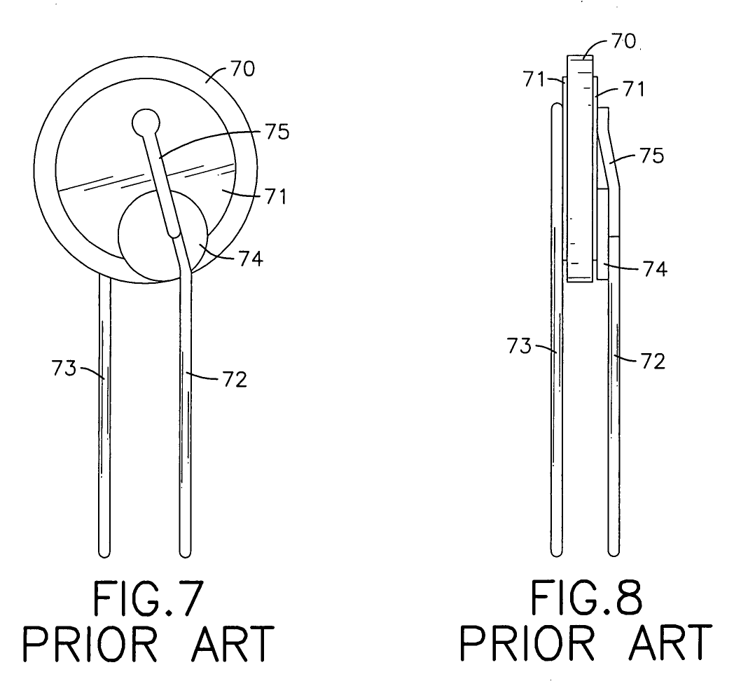

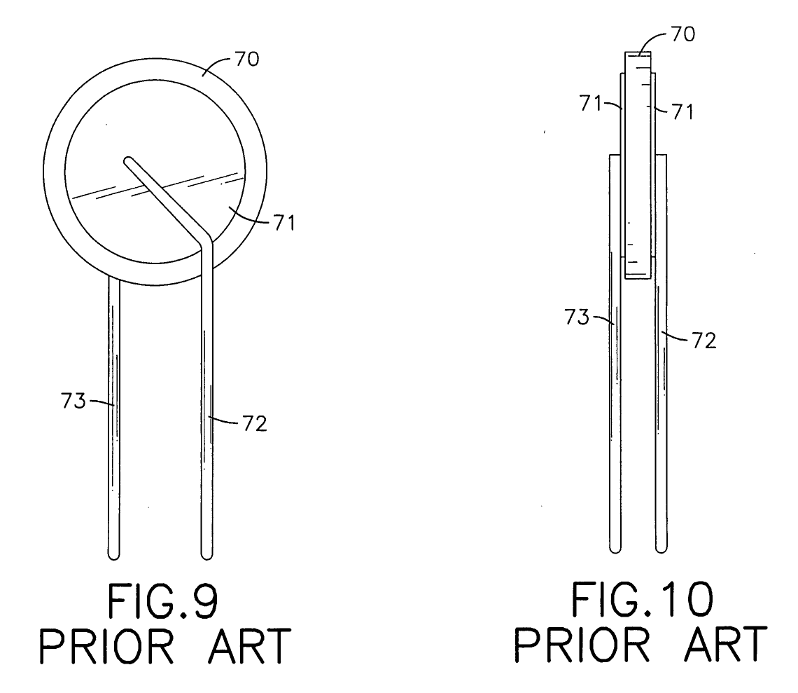

With further reference to FIGS. 3 and 4, the passive element further comprises an insulation substrate (50) and a fuse (60). The insulation substrate (50) is attached to one of the silver electrodes (20). The fuse (60) is mounted between the first terminal (30) and the metal pad (40) to provide over-current protection and has a first end and a second end. The first end of the fuse (60) connects to the first terminal (30) on the insulation substrate (50). The second end of the fuse (60) connects to the metal pad (40).

The metal pad (40) increases contact surface between the silver electrode (20) and the first terminal (30).

The metal pad (40) distributes current passing from the metal pad (40) to the silver electrode (20) over a greater area so heating caused by the current is also distributed over a greater area. Therefore, the present invention is not damaged easily and can work normally most of the time.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A passive element having an ability to withstand inrush current and comprising two electrodes and two terminals connecting respectively to each electrode, wherein the improvement comprises a metal pad mounted between one of electrodes and a corresponding terminal.

2. The passive element as claimed in claim 1 further comprising a ceramic disc mounted between the electrodes.

3. The passive element as claimed in claimed 1 further comprising a fuse mounted between one of the electrodes and a corresponding one of the corresponding terminals.

4. The passive element as claimed in claimed 2 further comprising a fuse mounted between one of the electrodes and a corresponding one of the corresponding terminals.

5. The passive element as claimed in claim 3 further comprising an insulation substrate mounted under a contacting surface of one of the terminals and the fuse and attached on a corresponding electrode.

6. The passive element as claimed in claim 4 further comprising an insulation substrate mounted under a contacting surface of one of the terminals and the fuse and attached on a corresponding electrode.

7. The passive element as claimed in claim 1, wherein the metal pad is a copper sheet.

8. The passive element as claimed in claim 6, wherein the metal pad is a copper sheet.

9. The passive element as claimed in claim 1, wherein the electrodes are silver electrodes.

10. The passive element as claimed in claim 8, wherein the electrodes are silver electrodes.

11. The passive element as claimed in claim 1, wherein the passive element is a metal oxide varistor.

12. The passive element as claimed in claim 3, wherein the passive element is a thermal metal oxide varistor.

13. A method to increase a passive element's capacity to accommodate inrush current, wherein the passive element has a current path with a current, and the method comprising an act of mounting a metal pad in the current path of the passive element to allow the current to pass through the metal pad and the passive element and to distribute the current passing through the metal pad over a greater area.

14. The method as claimed in claim 13, wherein the metal pad is a copper sheet.
